(19) United States
(12) Patent Application Publication
(10) Pub. No.: US 2018/0056601 A1
(43) Pub. Date: Mar. 1, 2018

(54) ULTRASONIC SEALER

(71) Applicant: Kimberly-Clark Worldwide, Inc., Neenah, WI (US)

(72) Inventors: Gregory John Rajala, Neenah, WI (US); Kenneth John Wagner, Greenville, WI (US); Jason Kyle Sieck, Neenah, WI (US); Brian Keith Rhodes, Winneconne, WI (US)

(21) Appl. No.: 15/557,962

(22) PCT Filed: Jan. 29, 2016
(86) PCT No.: PCT/US16/15538

§ 371 Date: Sep. 13, 2017

(51) Int. Cl. B29C 65/00; B29C 65/08

(52) U.S. Cl. CPC B29C 66/9516; B29L 2031/4878; B29C 65/087

(57) ABSTRACT

An energy system for applying energy to a workpiece includes a first energy application device, mounted such that the first energy application device has a fixed position relative to the workpiece during energy application; a second energy application device, mounted such that the second energy application device has a moveable position relative to the workpiece to apply energy to the workpiece at a point moving progressively across the workpiece, wherein one of the first and second energy application devices is an anvil and the other of the first and second energy application devices is an ultrasonic bonder; and a controller for regulating the application of energy to the workpiece, wherein the controller is configured to adjust progressively across the workpiece one or more of bonder vibration amplitude versus position on the workpiece, bonder pressure versus position on the workpiece, and horn travel velocity versus position on the workpiece.

### BACKGROUND

This disclosure relates to apparatus and methods for applying thermal energy to workpieces, such as for bonding, sealing, cutting and the like of the workpieces.

Use of mechanical vibration produced at an ultrasonic frequency to weld thermoplastics, and to emboss and form plastics is a well-established industrial process. The physical principles underlying this technology have important relations to the disclosure described herein and therefore merit brief review and discussion.

To obtain significant vibrational motion, most ultrasonic systems are operated at one of their frequencies of resonance. Both the ultrasonic generator and the ultrasonic horn are designed to resonate at the same frequency, in which case the vibration produced by the generator is communicated to the horn. Because the horn is tuned to the same frequency as the generator, the horn expands and contracts along its length in concert with the imposed motion of the vibration generator.

The motion produced at the free face of the horn is then reciprocal, or back and forth in a surface perpendicular to the surface of the horn, with an amplitude determined by the electrical voltage applied to the crystals of the vibration generator. It is known to condition the vibrations produced by the generator before the vibrations are communicated to the horn, including incorporating amplification devices and phase change devices into the sequence of elements so used.

The present disclosure provides an ultrasonic system including an ultrasonic horn and a cooperating anvil wherein one of the horn and anvil is mounted on a rotating web-carrying work drum. The other of the horn and anvil is mounted for rotation with the work drum, extends over the work drum to apply ultrasonic energy to a workpiece, and withdraws from over the work drum during each rotation of the work drum. The system can include a plurality of sets of horns and anvils disposed about the circumference of the work drum, wherein the system can simultaneously process a related plurality of workpieces.

### SUMMARY

Some current side seam bonders such as those described in U.S. Pat. Nos. 5,660,679 and 5,660,657 have employed six 40 KHz ultrasonic bonders arranged around a drum. This arrangement provides about 4.5 products worth of dwell time to make a bond and stabilize a given workpiece before the workpiece moves on to further processing. As machine speeds have increased and product designs have changed, the need for improved and more efficient bonding has become apparent. The present disclosure outlines particular configurations that allow a side seam bonder higher speed capability and the ability to accommodate a wider variety of product designs.

The present disclosure is generally directed to an energy system for applying energy to a workpiece, the energy system including a first energy application device, mounted such that the first energy application device has a fixed position relative to the workpiece during energy application; a second energy application device, mounted such that the second energy application device has a moveable position relative to the workpiece during energy application to thereby extend over the first energy application device, to operate in combination with the first energy application device, to apply energy to the workpiece at a point moving progressively across the workpiece, and to subsequently withdraw from over the first energy application device, wherein one of the first and second energy application devices is an anvil and the other of the first and second energy application devices is an ultrasonic bonder having an ultrasonic horn, a bonder vibration amplitude, a bonder pressure, and a horn travel velocity; and a controller for regulating the application of energy to the workpiece, wherein the controller is configured to adjust progressively across the workpiece one or more of bonder vibration amplitude versus position on the workpiece, bonder pressure versus position on the workpiece, and horn travel velocity versus position on the workpiece.

The present disclosure is also generally directed to an energy system for applying energy to a workpiece including a drum, mounted for rotation about a first axis in a given direction, the drum having a circumferential outer working surface; a first energy application device, mounted on the drum at the outer working surface, and extending transverse to the direction of rotation of the drum; a second energy application device, mounted for rotation with the drum, and for moving in a direction transverse to the direction of rotation of the drum to thereby extend over the first energy application device, and operate in combination with the first energy application device, to apply energy to the workpiece at a point moving progressively across the workpiece during rotation of the drum, and for subsequently withdrawing from over the first energy application device during rotation of the drum, wherein one of the first and second energy application devices is an anvil and the other of the first and second energy application devices is an ultrasonic bonder having a bonder vibration amplitude, a bonder power, a bonder pressure, and a horn travel velocity; and a controller for regulating the application of energy to the workpiece, wherein the controller is configured to adjust progressively across the workpiece one or more of bonder vibration amplitude versus position on the workpiece, bonder pressure versus position on the workpiece, and horn travel velocity versus position on the workpiece.

The present disclosure is also generally directed to a method for applying energy to a workpiece includes providing a complex workpiece having variable thickness and/or number of layers across a cross-direction; positioning the workpiece between an anvil and an ultrasonic horn, wherein the ultrasonic horn has a bonder vibration amplitude, a bonder pressure, and a horn travel velocity, and wherein one of the ultrasonic horn and the anvil is fixe, and the other of the ultrasonic horn and the anvil is configured to travel across the workpiece and apply energy to the workpiece; and customizing the energy delivered to the workpiece by controlling one or more of bonder vibration amplitude, bonder pressure, and horn travel velocity as a function of position on the workpiece and the thickness and/or number of layers of the workpiece at a given position.

Other features and aspects of the present disclosure are discussed in greater detail herein.

### BRIEF DESCRIPTION OF THE DRAWINGS

The present disclosure will be more fully understood, and further features will become apparent, when reference is made to the following detailed description and the accompanying drawings. The drawings are merely representative and are not intended to limit the scope of the claims.

FIG. 1 is a perspective view of a workpiece that can be made using methods and apparatus of this disclosure.

FIG. 2 is a top view of a finished workpiece blank, as a workpiece in a continuous web, from which the workpiece of FIG. 1 can be made.

FIG. 3 is a pictorial view, with parts missing and parts cut away, showing a thermal energy system of the disclosure.

FIG. 4 is a cross-section of the thermal energy system of FIG. 3, taken at planar section 4-4 of FIG. 3.

FIG. 5 is a schematic representation of an end elevation view of the thermal energy system of FIG. 3.

FIG. 6 is a top view of the first thermal energy application device, taken at 6-6 of FIG. 3.

FIG. 7 is a side view of the first thermal energy application device of FIG. 6.

FIG. 8 is a cross-section as in FIG. 4, of a second aspect of thermal energy systems of the disclosure.

Repeat use of reference characters in the present specification and drawings is intended to represent the same or analogous features or elements of the present disclosure. The drawings are representational and are not necessarily drawn to scale. Certain proportions thereof might be exaggerated, while others might be minimized.

### DETAILED DESCRIPTION

It is to be understood by one of ordinary skill in the art that the present discussion is a description of exemplary aspects only, and is not intended as limiting the broader aspects of the present disclosure.

The following detailed description of the illustrated aspects is made in the context of making disposable type garments such as diapers, training pants, feminine care products, incontinence garments, and the like, although joining any suitable materials in other contexts is envisioned. The system includes apparatus and methods for joining two superposed webs by producing ultrasonic welds at spaced locations extending across the webs in directions transverse (cross machine direction) to the direction of travel of the webs in the processing apparatus (with machine direction). The specific context is the production of disposable type garments in a continuous combined web, where the garment preforms in the web extend transverse to the web, with the waist portions of the garments extending along the machine direction of the web, and the front and back portions of the garments being on opposing sides of the web. In the aspects illustrated, the welds join the superposed webs at locations generally corresponding to the ultimate locations of side seams in the finished garments.

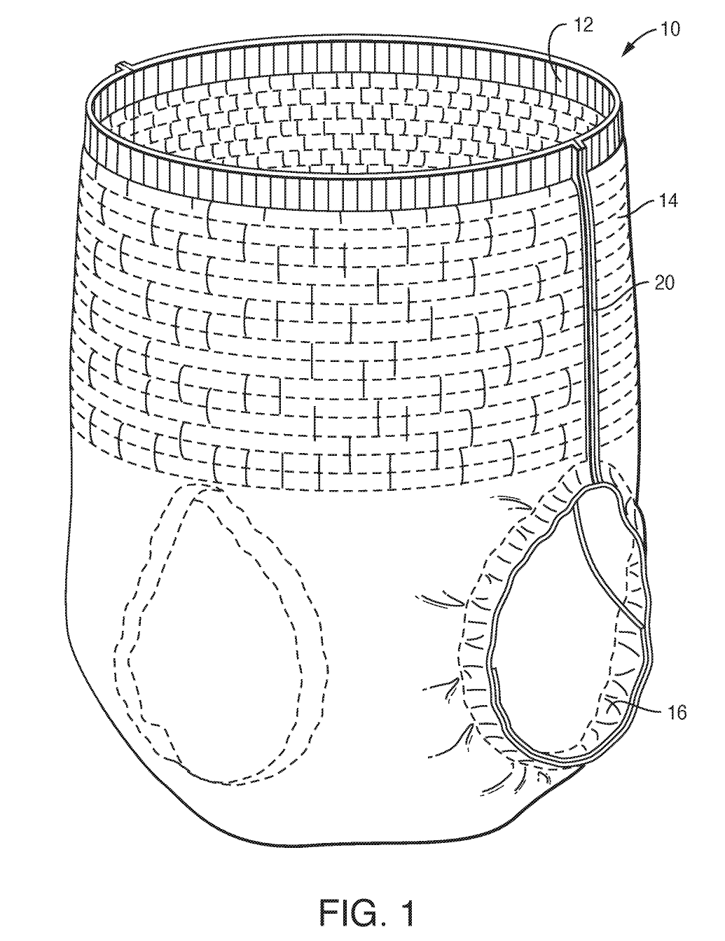

It is generally known to make a garment 10 of the type shown in FIG. 1. Such garments typically include an assemblage of two or more layers or partial layers of different materials or can include substantially the same materials, along with other elements. Typically, the material is a woven or non-woven fabric, or a polymer film. Elastic can be used at the waist 12, in the body portion 14, and around the leg openings 16.

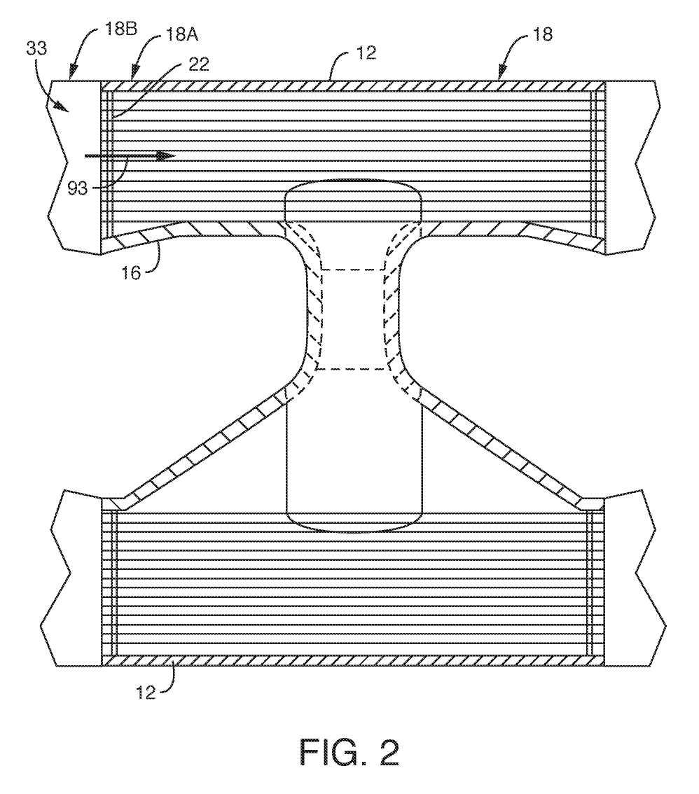

In this context, as in most such processes for fabricating the garment as at 10, a blank 18 such as that shown in FIG. 2 is first made as part of a continuously processed composite web of materials. After the blank is fully fabricated, the side seams 20 are formed and the garment is severed from the web either as a blank, fully finished or partially finished, or as a fully formed garment article.

The process contemplated by the disclosure forms the welds 22 adjacent the adjoining edges of leading and trailing blanks 18A and 18B as illustrated in FIG. 2. In forming such transverse welds using known technology, it is difficult to obtain uniform application of thermal energy across the entire width of the web, whereby the welds can exhibit less than the desired uniformity. The apparatus and methods disclosed hereinafter provide a novel approach to achieving predictably uniform such welds in the blanks being formed.

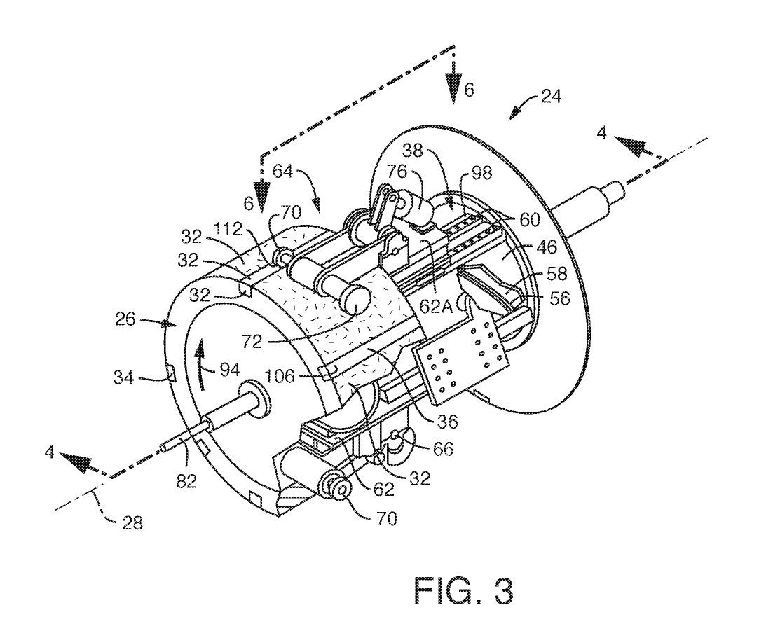

A current side seam bonder is described in U.S. Pat. Nos. 5,667,608 and 5,660,679 to Rajala et al., which are incorporated by reference herein to the extent they do not conflict herewith. The bonder includes six stations evenly spaced about a circle with each station containing an ultrasonic bonder having anvils that work in conjunction with ultrasonic horns to create cross-direction bonds on a continuous web or webs of material. FIGS. 3-7 illustrate one aspect of a thermal energy system of the disclosure. The thermal energy system can include any device through which the transfer of thermal energy is sufficient to weld the material together, such as electrical resistance devices such as continuously heated or intermittently heated impulse type devices, or induction heated components. The preferable thermal energy source is by the use of ultrasonics.

As seen in FIGS. 3-7, an ultrasonic system 24 includes a work drum 26 mounted on an outer shaft 25, for rotation about an axis 28 passing through a fixed inner shaft generally designated as 30. The work drum 26 has an outer working surface 32 perforated and otherwise adapted in conventional manner (not shown) to provide suction through the outer working surface of the work drum 26, to hold a web 33 of material workpieces that, when all processing is finished, can be assembled as blanks 18 into the garment articles 10.

A plurality of anvil bars 34 (six are shown) are mounted to the work drum, spaced uniformly about the outer circumference of the work drum, and extend transversely across the width dimension of the outer working surface of the work drum 26. The anvil bars are flush with the outer working surface 32, such that outer surfaces 36 of the anvil bars 34 generally include a continuation of the outer working surface 32 of the work drum 26. Increasing the number of stations increases dwell time for a given workpiece, as described in more detail below.

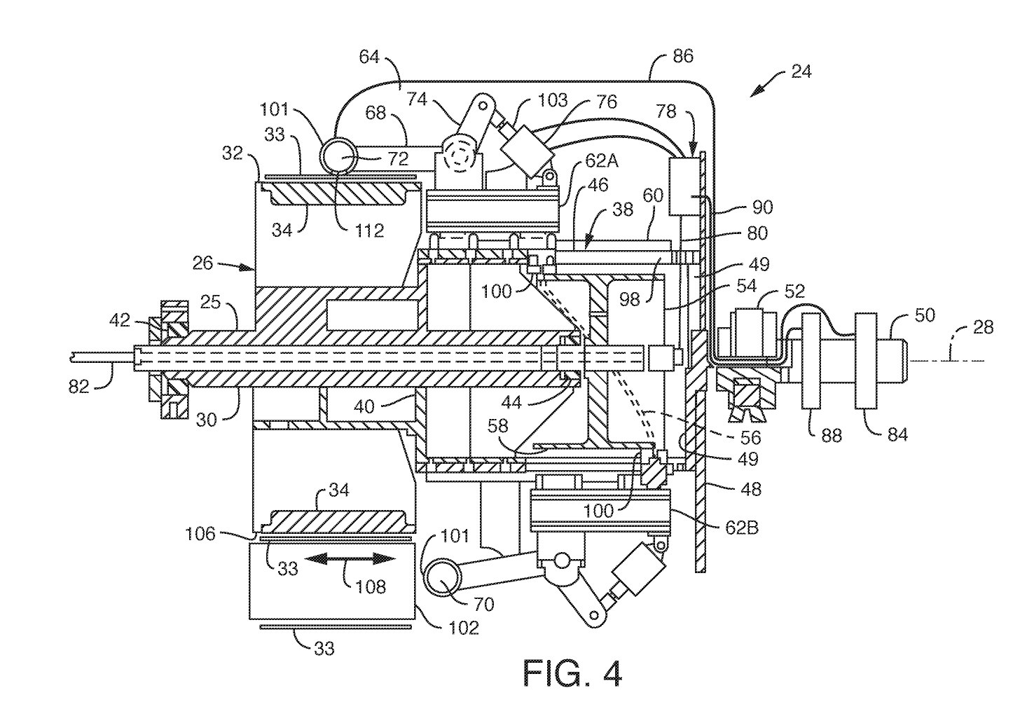

A support drum 38 is secured to the work drum 26, and mounted for rotation with the work drum. Referring to FIG. 4, the support drum 38 is secured to work drum 26 at interface wall 40. The combination of the work drum 26 and the support drum 38 are mounted to the outer shaft 25. Outer shaft 25 is mounted to the fixed inner shaft 30 by bearings 42 and 44. An outer wall 46 of the support drum 38 is secured to end flange 48 through end wall 49. End flange 48 is secured to driven shaft 50 that is driven off the line shaft, not shown, of the processing line. Driven shaft 50 is mounted to ground through bearing 52. Accordingly, the work drum 26, the support drum 38, and the end flange 48 are all supported by the combination of bearings 42, 44, and 52, and all rotate in unison about fixed inner shaft 30 and the axis 28.

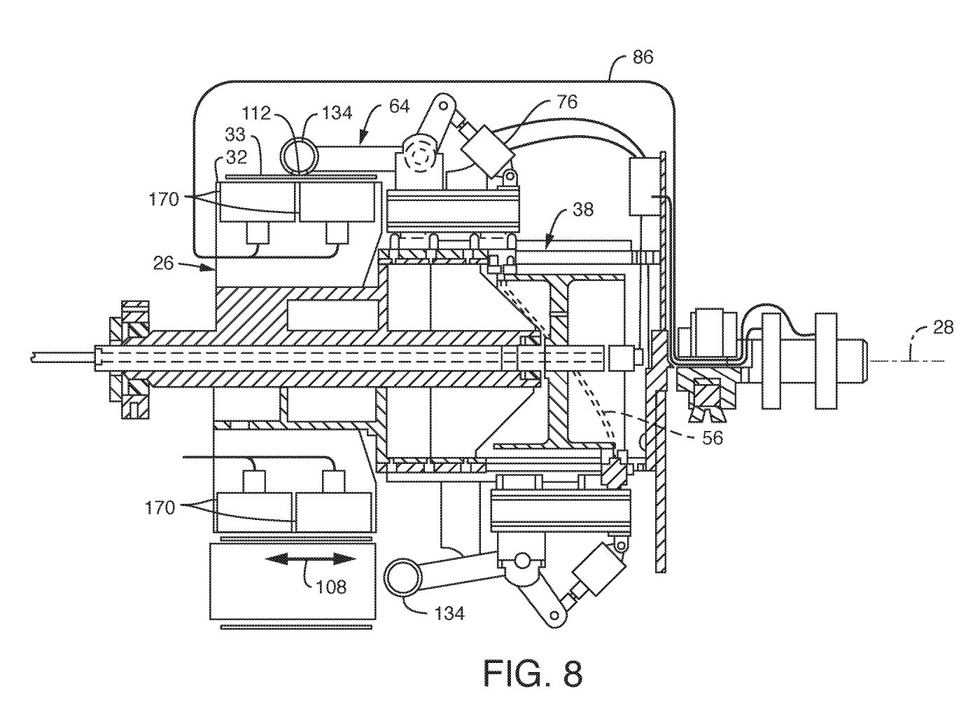

Cam drum 54 is fixedly secured to fixed inner shaft 30, such that it does not rotate with the combination of work drum 26, support drum 38, and end flange 48. Cam rib 56 is mounted on the outer wall 58 of the cam drum 54, and extends about the entire circumference of the outer wall 58 of the cam drum. Cam rib 56 is seen in dashed outline in FIGS. 4 and 8. A portion of the cam rib is seen through a cutaway portion of the outer wall 46 of the support drum in FIG. 3.

Six pairs of carriage support tracks 60 are secured to the outer wall 58 of cam drum 54, corresponding in number, and in general location, to respective anvil bars 34 on the outer working surface 32 of work drum 26. A carriage 62 is mounted to each pair of carriage support tracks 60, for sliding engagement with the carriage support tracks, along the lengths “L” of the respective carriage support tracks, as will be illustrated further hereinafter.

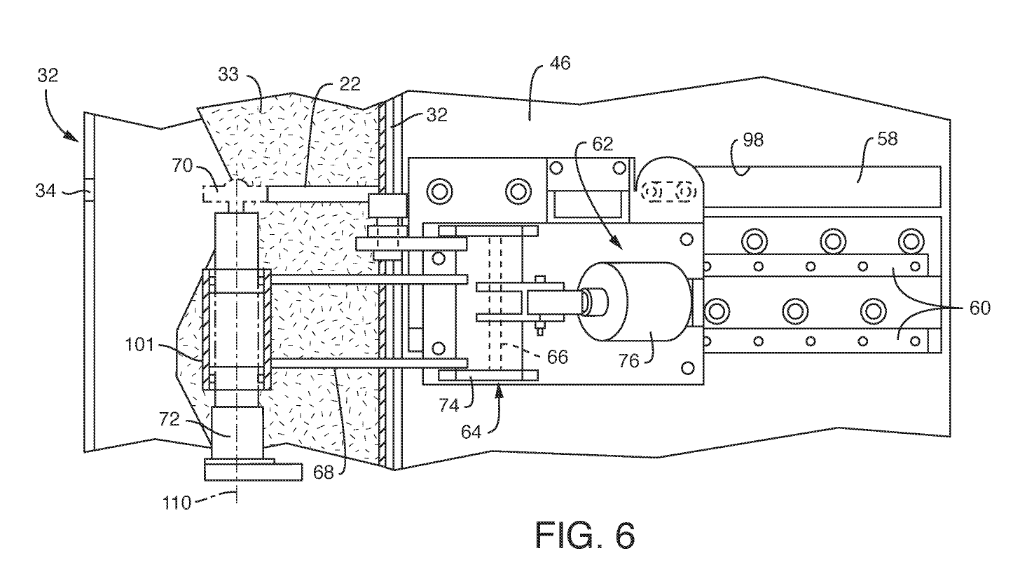

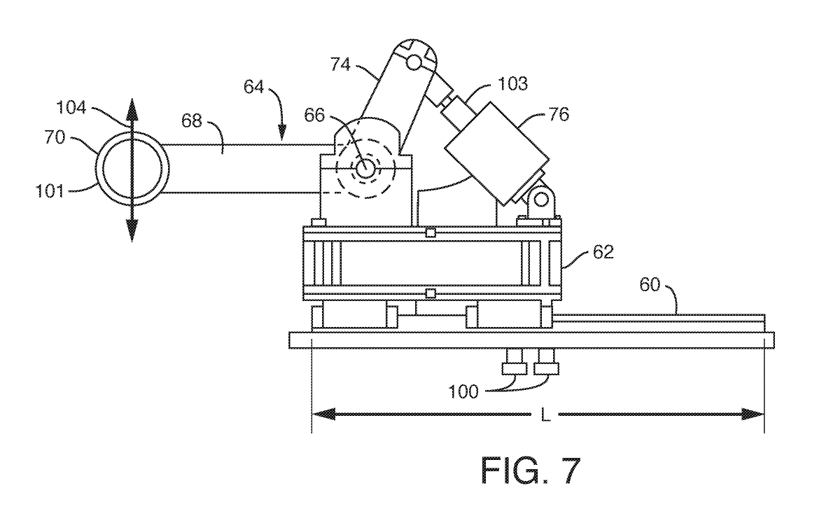

Referring now to FIGS. 6 and 7, an ultrasonic support subassembly 64 is mounted to each carriage 62 at pivot pin 66. In the ultrasonic support subassembly 64, support arm 68 extends from pivot pin 66, toward outer working surface 32 of the work drum 26, and supports, at its remote end, a rotary ultrasonic horn 70 and ultrasonic generator 72. Support arm 68 is fixedly secured to control arm 74. Control arm 74 is operated by double acting air cylinder 76, acting through pivot pin 66 and control arm 74, to pivot the ultrasonic horn 70 about pivot pin 66 and thereby to raise and lower the ultrasonic horn 70 with respect to the outer working surface 32 of work drum 26. Thus, the ultrasonic support subassembly 64 includes pivot pin 66, support arm 68, and control arm 74.

Compressed air is supplied to the air cylinder 76 from pneumatic control box 78. See FIG. 4. Compressed air is supplied to the pneumatic control box 78 through supply line 80, which is connected, through a conventional rotary pneumatic coupling to fixed shaft 30. Air is supplied through the center of fixed shaft 30 from a supply line 82.

Electric power is supplied to the ultrasonic system 24 through slip rings 84, and is communicated to the ultrasonic generators through supply line 86.

Programmable limit switch 88 is also mounted to the driven shaft 50, for purpose to be discussed hereinafter. Output of the programmable limit switch 88 is fed to the control box 78 through electric line 90.

It is contemplated that the operation and functions of the disclosure have become fully apparent from the foregoing description of elements and their relationships with each other, but for completeness of disclosure, the usage of the disclosure will be briefly described.

Turning now to FIG. 4, driven shaft 50 turns end flange 48, work drum 26, support drum 38 and its supported carriages 62, ultrasonic support subassemblies 64, ultrasonic horns 70, and generators 72, continuously at a steady speed of rotation. An incoming turning roll 92 is disposed at a placing station, relative to a reference line through axis 28, at an angle “P” on the circumference of the work drum 26. A web 33 of workpieces or other material is fed, in the direction indicated by arrow 93 about incoming turning roll 92, and is thereby drawn into engagement with the working surface 32 of the work drum 26, at the nip formed between work drum 26 and turning roll 92, while the work drum is rotating in the direction indicated by the arrow 94. The web 33 is generally drawn about the circumference of work drum 26 at its outer working surface from incoming turning roll 92 until it reaches the outgoing turning roll 96, at the removing station disposed at an angle “R” on the circumference of the work drum. At outgoing turning roll 96, the web 33 turns about the turning roll 96 as indicated there by the web 33, and is thus removed from the work drum and exits the process of interest in this disclosure.

In general, as the disclosure is practiced, the ultrasonic horns are continuously activated, resonating at their designed frequencies.

Turning to the combination of FIGS. 3-7, a slot opening 98 extends through the outer wall 46 of support drum 38 adjacent each carriage support track 60. A pair of cam followers 100 extends downwardly from each respective carriage, through slot opening 98, and engages the rib cam 56. Accordingly, as the working drum and support drum rotate on axis 28, about the stationary cam drum 54, the engagement of the cam followers 100 with the rib cam 56 causes the carriages 62 to move alternately toward and away from the outer working surface 32 of the work drum 26. Each carriage thus makes one complete round trip motion, toward the work drum and away from the work drum, for each 360 degree rotation of the work drum. Accordingly, and now referring to FIGS. 3-5, the carriage 62A at the 12 o′clock position on support drum 38 is fully extended toward the work drum; and the carriage 62B at the 6 o′clock position on support drum 38 is fully withdrawn away from the work drum.

As the carriages extend toward the work drum 26, the respective ultrasonic horns extend over the outer working surface 32 of the work drum, and over the corresponding anvil bar 34. As the carriages withdraw from the work drum, the respective ultrasonic horns withdraw from over the outer working surface of the work drum.

An ultrasonic horn is considered fully withdrawn from over the outer working surface 32 when the remote outer edge 101 of the combination of the ultrasonic support assembly 64, horn 70, and generator 72, passes inwardly of the inner edges 102 of turning rolls 92 and 96. See FIG. 4, where the horn on carriage 62B is fully withdrawn, and has moved still further away from the work drum than the defined “fully withdrawn” position. Accordingly, “fully withdrawn” comprehends a range of positions of the outer edge 101 disposed inwardly of the inner edges 102 of the turning rolls 92 and 96, and is not limited to the innermost position where the carriage 62 is disposed in its most remote position with respect to the work drum.

As each carriage 62 extends toward the work drum, and the respective ultrasonic horn 70 is correspondingly disposed over the outer working surface 32, programmable limit switch 88 signals the pneumatic control box 78, thus activating and extending the ram 103 on the respective air cylinder 76 to thus move the respective resonating ultrasonic horn 70 downwardly, as shown by the double headed arrow indicated as 104 in FIG. 7, and into contact with the workpiece being carried in the web 33 at the respective work station 106 defined at each respective anvil bar 34. The rotary ultrasonic horn 70 exerts a downward force on the workpiece against the supporting resistance of the anvil bar. The amount of downward force is controlled by the force exerted at air cylinder 76. This downward force is otherwise known as bonder pressure.

With the resonating rotary ultrasonic horn thus exerting a downward force on the workpiece, the circular rotary horn 70 is allowed to rotate about an axis 110 as it provides an effective application of ultrasonic energy to the workpiece at a point 112 moving progressively across the workpiece as the ultrasonic horn traverses across the working surface in an energy application path 108. As indicated in FIG. 4, the energy application path can extend less than all the way across the web; or can extend all the way across the web, depending on what work is to be performed by the ultrasonic energy, and the lengths of carriage support tracks 60 and support arm 68.

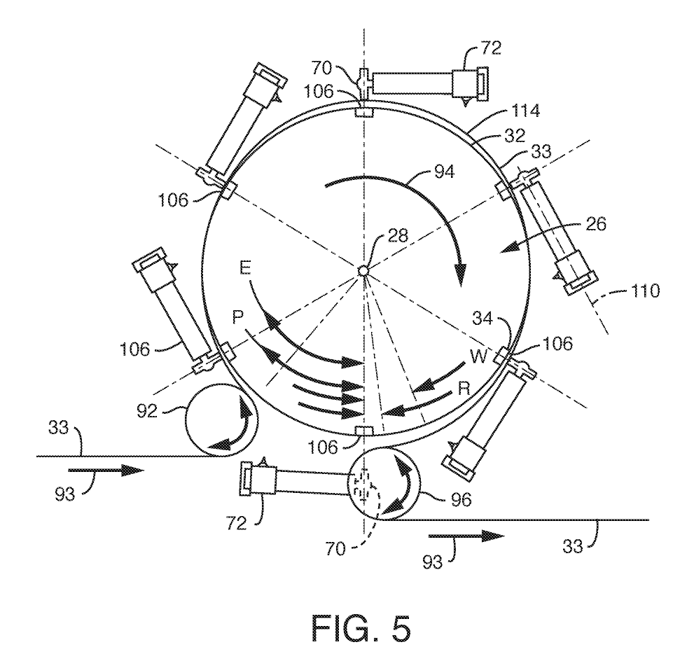

Preferably, the ultrasonic horn 70 is forced downwardly into working contact with the workpiece while the horn is traversing the outgoing segment of the energy application path. When the respective ultrasonic horn reaches the outer extremity of the outgoing segment of the energy application path, limit switch 88 senses the respective associated angular position of the working station with respect to axis 28, and signals the pneumatic control box 78, lifting the horn from the workpiece as the horn is being withdrawn from over the workpiece on the (reverse direction) incoming segment of the energy application path. Referring to FIG. 5, the horn begins being extended over the drum, namely crossing the inner edge 102 of the turning rolls 92, 96 at an angle “E” on the outer circumference of the work drum, and is fully withdrawn from over the outer working surface at an angle “W” on the outer circumference of the work drum. Referring to FIG. 5, the respective horn assembly is fully withdrawn before the respective workpiece in web 33 arrives at the turning roll 96 where the workpiece and web are removed from the work drum 26. Similarly, the horn assembly, including horn 70, generator 72, and ultrasonic support subassembly 64, remains fully withdrawn, and does not begin being extended over the outer working surface 32 until the horn assembly has passed the incoming turning roll 92 and the outer working surface is again becoming engaged with the incoming web of workpieces.

The working drum 26 thus rotates continuously, accompanied by the ultrasonic horns 70. Workpieces enter the ultrasonic system 24 as they are placed on the work drum 26 as part of web 33, and traverse the working path 114 between the placing station at angle “P” and the removing station at an angle “R,” while the ultrasonic application devices, as horns 70 and anvils 34, form the welds 22. Each horn thus extends across the outer working surface at the respective anvil to make a weld in the workpiece with each rotation of the work drum. The welds 22 extend in the cross machine direction. At any given time, the combined apparatus can support performing welding, cutting, or the like operations on substantially as many workpieces as there are work stations 106, and corresponding workpieces, on the drum between the turning rolls 92 and 96, allowing sufficient clearance for “full withdrawal” of the respective horns from the outer working surface so that the web with the finished workpieces can be removed at turning roll 96.

Suitable rotary ultrasonic horns 70 are, for example, those taught in U.S. Pat. No. 5,110,403 to Ehlert, herein incorporated by reference for its teaching with respect to suitable rotary ultrasonic horns. Suitable ultrasonic generators, and other related ultrasonic equipment, are available from a variety of suppliers, for example, Sonic Power Company, Danbury, Conn.

FIG. 8 shows a second aspect of the disclosure wherein the ultrasonic horn and the cooperating anvil are disposed in physically reversed locations from the aspect of FIGS. 3-7. Thus, comparing the aspect of FIG. 8 to the aspect described in more detail with respect to FIGS. 3-7, in FIG. 8, a pair of conventional plunge-type ultrasonic horns 170 are mounted in the work drum 26 in place of the anvil bar 34. As many plunge type horns can be used as necessary to span the full width of the energy application path. Correspondingly, a rotary anvil 134 is mounted to the ultrasonic support assembly 64 in place of the rotary ultrasonic horn 70.

In use, the ultrasonic horns 170 are preferably activated continuously during operation of the process. Work drum 26 and support drum 38 rotate continuously as described above. As the drums rotate, the anvil is extended over the working surface, and forced into working contact with the workpieces by air cylinder 76 as the anvil traverses the outgoing segment of the energy application path 108, and lifts the anvil from the workpiece as it traverses the incoming segment of the energy application path. The significant difference is that the locations of the ultrasonic horn and the anvil are reversed, while the physical movement role of extending over the outer working surface and subsequently withdrawing remains embodied in the elements mounted on carriage 62. Accordingly, the ultrasonic application device mounted in the outer working surface of the work drum is the device supplying the ultrasonic energy, rather than the ultrasonic application device mounted on the ultrasonic support subassembly 64.

Alternatively, other energy application devices can be substituted for the ultrasonic devices. Such devices include pressure bonders, electric resistance heating elements, electric indicator elements, and fluid heated elements.

The strength of a bond delivered by an ultrasonic bonder of the present disclosure is largely a function of amplitude, force, and time. In general, more energy is required to effectively bond thicker materials or a larger number of layers of materials. Because excess energy can create holes in the materials and other problems, the amount of energy delivered to a workpiece must be controlled, particularly with respect to complex and variable materials.

Controlling multiple variables allows for higher speed operations and for complex and variable product design. First, adding dwell time, the time a workpiece is available on the ultrasonic bonder for bonding operations, can be accomplished by adding stations from the typical six to seven or more. Increasing the number of stations, for example to seven or more, has, at a given machine speed, the benefit of increasing dwell time while lowering the centrifugal force that tends to unload the ultrasonic horn from its anvil when compared to the typical six-station configuration.

Second, bonder vibration amplitude capability can be increased by using bonders that operate at a frequency lower than 40 KHz. Amplitude capability tends to increase as ultrasonic frequency is lowered. Increasing the amplitude of vibration has the benefit of allowing higher bonding energy compared to 40 KHz. The higher amplitude is especially helpful when processing webs that have multiple and/or thick layers.

Third, bonder amplitude versus position on the workpiece can be controlled and varied depending on the materials being bonded. Controlling amplitude versus position on the workpiece has the benefit of allowing high energy to be applied to certain areas of the workpiece, and less energy input in other areas. For example, a portion with four or more layers needs a certain energy input to bond correctly, while another portion with two layers would be over bonded or destroyed if subjected to the energy required by the four-layer portion. In amplitude control the ultrasonic generator's voltage output, and therefore vibration amplitude, is proportional to a control setpoint. In this configuration, the amplitude setpoint is adjusted according to the position on the workpiece.

Fourth, bonder power versus position on the workpiece can be controlled and varied depending on the materials being bonded. The amplitude at which an ultrasonic system vibrates is proportional to the voltage applied to the ultrasonic converter. The amount of current drawn by the ultrasonic converter depends upon the work being done by the vibrating electro-mechanical ultrasonic system; the work being done depends on the amplitude of vibration (i.e., applied voltage) and the applied force. The applied voltage and the supplied current determines the power (rate of doing work) drawn by the ultrasonic system. In power control the applied voltage is automatically adjusted so that the system power (voltage times current) remains at a setpoint value. Adjusting the power versus workpiece position involves adjusting the power setpoint depending on the position of the ultrasonic bonder on the workpiece.

Fifth, bonder pressure versus position on the workpiece can be controlled and varied depending on the materials being bonded. Controlling bonder pressure versus position on the workpiece has the benefit of allowing bond energy to be tailored to the requirements at any given position along the workpiece. In this configuration the pressure to the air cylinders that load the ultrasonic horn against the workpiece is adjusted so that the force component of the ultrasonic bond strength function mentioned above is proportional to a programmable setpoint. The setpoint is adjusted depending upon the position of the ultrasonic horn on the workpiece.

Sixth, horn travel velocity versus position on the workpiece can be controlled and varied depending on the materials being bonded. Horn travel velocity and duration affects the time component of the bond strength function. In one aspect, controlling horn travel velocity involves constructing the cam that moves the ultrasonic bonder back and forth over the workpiece web so that at a given machine speed the bonder moves at as slow a velocity as possible, given the physical constraints for crash avoidance. This configuration can also include tailoring the cam so that it provides multiple velocity zones over a workpiece so that at a given machine speed the velocity and duration for a given zone are optimum for that zone. In various aspects, horn travel velocity can be controlled/varied across the workpiece by using a cam system, linear actuator, servos, controllers, or any other suitable control system.

Various configurations of a side seam bonder allow optimizing bond strengths for a particular workpiece design. Bond strength can be optimized by providing additional stations, increased bonder amplitude by reducing operating frequency, and four customizations versus position on a workpiece: amplitude, power, pressure, and horn travel velocity.

In a first particular aspect, an energy system for applying energy to a workpiece includes a first energy application device, mounted such that the first energy application device has a fixed position relative to the workpiece during energy application; a second energy application device, mounted such that the second energy application device has a moveable position relative to the workpiece during energy application to thereby extend over the first energy application device, to operate in combination with the first energy application device, to apply energy to the workpiece at a point moving progressively across the workpiece, and to subsequently withdraw from over the first energy application device, wherein one of the first and second energy application devices is an anvil and the other of the first and second energy application devices is an ultrasonic bonder having an ultrasonic horn, a bonder vibration amplitude, a bonder pressure, and a horn travel velocity; and a controller for regulating the application of energy to the workpiece, wherein the controller is configured to adjust progressively across the workpiece one or more of bonder vibration amplitude versus position on the workpiece, bonder pressure versus position on the workpiece, and horn travel velocity versus position on the workpiece.

A second particular aspect includes the first particular aspect, wherein one of the first and second energy application devices is a rotary horn, and the other of the first and second energy application devices is a rotary anvil.

A third particular aspect includes the first and/or second aspect, wherein one of the first and second energy application devices is a fixed blade horn, and the other of the first and second energy application devices is a rotary anvil.

A fourth particular aspect includes one or more of aspects 1-3, wherein one of the first and second energy application devices is a rotary horn, and the other of the first and second energy application devices is a fixed anvil.

A fifth particular aspect includes one or more of aspects 1-4, wherein the first and second energy application devices are used in conjunction with a rotating drum system.

A sixth particular aspect includes one or more of aspects 1-5, wherein the first and second energy application devices are used in conjunction with a conveyor system.

A seventh particular aspect includes one or more of aspects 1-6, the ultrasonic horn being mounted to extend over the anvil, to apply pressure on a workpiece on the anvil, and thereby to apply ultrasonic energy to the workpiece while extended over the anvil.

An eighth particular aspect includes one or more of aspects 1-7, the ultrasonic horn being mounted to traverse an energy application path over the anvil and a workpiece on the anvil, the energy application path being oriented transversely across the outer working surface, the ultrasonic system further comprising apparatus for simultaneously applying pressure and ultrasonic energy through the ultrasonic horn to the workpiece disposed on the anvil, at the point moving progressively across the workpiece, thereby to accomplish work on the workpiece while the ultrasonic horn is so traversing the energy application path and so applying pressure and ultrasonic energy to the workpiece.

A ninth particular aspect includes one or more of aspects 1-8, wherein the energy comprises one or more of thermal energy generated by electrical resistance and pressure from a pressure bonder.

In a tenth particular aspect, an energy system for applying energy to a workpiece includes a drum, mounted for rotation about a first axis in a given direction, the drum having a circumferential outer working surface; a first energy application device, mounted on the drum at the outer working surface, and extending transverse to the direction of rotation of the drum; a second energy application device, mounted for rotation with the drum, and for moving in a direction transverse to the direction of rotation of the drum to thereby extend over the first energy application device, and operate in combination with the first energy application device, to apply energy to the workpiece at a point moving progressively across the workpiece during rotation of the drum, and for subsequently withdrawing from over the first energy application device during rotation of the drum, wherein one of the first and second energy application devices is an anvil and the other of the first and second energy application devices is an ultrasonic bonder having a bonder vibration amplitude, a bonder power, a bonder pressure, and a horn travel velocity; and a controller for regulating the application of energy to the workpiece, wherein the controller is configured to adjust progressively across the workpiece one or more of bonder vibration amplitude versus position on the workpiece, bonder pressure versus position on the workpiece, and horn travel velocity versus position on the workpiece.

An eleventh particular aspect includes the tenth particular aspect, wherein the first and second energy application devices cooperate to thereby apply ultrasonic energy to a workpiece on the drum.

A twelfth particular aspect includes the tenth and/or eleventh aspects, the anvil comprising a metal bar mounted essentially flush with the outer working surface of the drum.

A thirteenth particular aspect includes one or more of aspects 10-12, the ultrasonic horn being mounted to extend over the anvil, and to subsequently withdraw from over the anvil, during each rotation of the drum.

A fourteenth particular aspect includes one or more of aspects 10-13, the ultrasonic horn being mounted to extend over the anvil, to apply pressure on a workpiece on the anvil, and thereby to apply ultrasonic energy to the workpiece while extended over the anvil.

A fifteenth particular aspect includes one or more of aspects 10-14, the ultrasonic horn being mounted to traverse an energy application path over the anvil and a workpiece on the anvil, the energy application path being oriented transversely across the outer working surface, the ultrasonic system further comprising apparatus for simultaneously applying pressure and ultrasonic energy through the ultrasonic horn to the workpiece disposed on the anvil, at the point moving progressively across the workpiece, thereby to accomplish work on the workpiece while the ultrasonic horn is so traversing the energy application path and so applying pressure and ultrasonic energy to the workpiece.

A sixteenth particular aspect includes one or more of aspects 10-15, wherein the energy comprises one or more of thermal energy generated by electrical resistance and pressure from a pressure bonder.

In a seventeenth particular aspect, a method for applying energy to a workpiece includes providing a complex workpiece having variable thickness and/or number of layers across a cross-direction; positioning the workpiece between an anvil and an ultrasonic horn, wherein the ultrasonic horn has a bonder vibration amplitude, a bonder pressure, and a horn travel velocity, and wherein one of the ultrasonic horn and the anvil is fixe, and the other of the ultrasonic horn and the anvil is configured to travel across the workpiece and apply energy to the workpiece; and customizing the energy delivered to the workpiece by controlling one or more of bonder vibration amplitude, bonder pressure, and horn travel velocity as a function of position on the workpiece and the thickness and/or number of layers of the workpiece at a given position.

An eighteenth particular aspect includes the seventeenth particular aspect, wherein the anvil and the ultrasonic horn are used in conjunction with a rotating drum system.

A nineteenth particular aspect includes the seventeenth and/or the eighteenth particular aspects, wherein the anvil and the ultrasonic horn are used in conjunction with a conveyor system.

A twentieth particular aspect includes one or more of aspects 17-19, the ultrasonic horn being mounted to extend over the anvil, to apply pressure on a workpiece on the anvil, and thereby to apply ultrasonic energy to the workpiece while extended over the anvil.

Having thus described the disclosure in full detail, it will be readily apparent that various changes and modifications can be made without departing from the spirit of the disclosure. All such changes and modifications are contemplated as being within the scope of the present disclosure, as defined by the following claims.

These and other modifications and variations to the present disclosure can be practiced by those of ordinary skill in the art, without departing from the spirit and scope of the present disclosure, which is more particularly set forth in the appended claims. In addition, it should be understood that elements of the various aspects can be interchanged both in whole and in part. Furthermore, those of ordinary skill in the art will appreciate that the foregoing description is by way of example only, and is not intended to limit the disclosure so further described in such appended claims.

What is claimed:

1. An energy system for applying energy to a workpiece, the energy system comprising:
a first energy application device, mounted such that the first energy application device has a fixed position relative to the workpiece during energy application;
a second energy application device, mounted such that the second energy application device has a moveable position relative to the workpiece during energy application to thereby extend over the first energy application device, to operate in combination with the first energy application device, to apply energy to the workpiece at a point moving progressively across the workpiece, and to subsequently withdraw from over the first energy application device, wherein one of the first and second energy application devices is an anvil and the other of the first and second energy application devices is an ultrasonic bonder having an ultrasonic horn, a bonder vibration amplitude, a bonder pressure, and a horn travel velocity; and
a controller for regulating the application of energy to the workpiece, wherein the controller is configured to adjust progressively across the workpiece one or more of bonder vibration amplitude versus position on the workpiece, bonder pressure versus position on the workpiece, and horn travel velocity versus position on the workpiece.

2. The energy system of claim 1, wherein one of the first and second energy application devices is a rotary horn, and the other of the first and second energy application devices is a rotary anvil.

3. The energy system of claim 1, wherein one of the first and second energy application devices is a fixed blade horn, and the other of the first and second energy application devices is a rotary anvil.

4. The energy system of claim 1, wherein one of the first and second energy application devices is a rotary horn, and the other of the first and second energy application devices is a fixed anvil.

5. The energy system of claim 1, wherein the first and second energy application devices are used in conjunction with a rotating drum system.

6. The energy system of claim 1, wherein the first and second energy application devices are used in conjunction with a conveyor system.

7. The energy system of claim 1, the ultrasonic horn being mounted to extend over the anvil, to apply pressure on a workpiece on the anvil, and thereby to apply ultrasonic energy to the workpiece while extended over the anvil.

8. The energy system of claim 1, the ultrasonic horn being mounted to traverse an energy application path over the anvil and a workpiece on the anvil, the energy application path being oriented transversely across the outer working surface, the ultrasonic system further comprising apparatus for simultaneously applying pressure and ultrasonic energy through the ultrasonic horn to the workpiece disposed on the anvil, at the point moving progressively across the workpiece, thereby to accomplish work on the workpiece while the ultrasonic horn is so traversing the energy application path and so applying pressure and ultrasonic energy to the workpiece.

9. The energy system of claim 1, wherein the energy comprises one or more of thermal energy generated by electrical resistance and pressure from a pressure bonder.

10. An energy system for applying energy to a workpiece, comprising:
a drum, mounted for rotation about a first axis in a given direction, the drum having a circumferential outer working surface;
a first energy application device, mounted on the drum at the outer working surface, and extending transverse to the direction of rotation of the drum;
a second energy application device, mounted for rotation with the drum, and for moving in a direction transverse to the direction of rotation of the drum to thereby extend over the first energy application device, and operate in combination with the first energy application device, to apply energy to the workpiece at a point moving progressively across the workpiece during rotation of the drum, and for subsequently withdrawing from over the first energy application device during rotation of the drum, wherein one of the first and second energy application devices is an anvil and the other of the first and second energy application devices is an ultrasonic bonder having a bonder vibration amplitude, a bonder power, a bonder pressure, and a horn travel velocity; and
a controller for regulating the application of energy to the workpiece, wherein the controller is configured to adjust progressively across the workpiece one or more of bonder vibration amplitude versus position on the workpiece, bonder pressure versus position on the workpiece, and horn travel velocity versus position on the workpiece.

11. The energy system of claim 10, wherein the first and second energy application devices cooperate to thereby apply ultrasonic energy to a workpiece on the drum.

12. The energy system of claim 10, the anvil comprising a metal bar mounted essentially flush with the outer working surface of the drum.

13. The energy system of claim 10, the ultrasonic horn being mounted to extend over the anvil, and to subsequently withdraw from over the anvil, during each rotation of the drum.

14. The energy system of claim 10, the ultrasonic horn being mounted to extend over the anvil, to apply pressure on a workpiece on the anvil, and thereby to apply ultrasonic energy to the workpiece while extended over the anvil.

15. The energy system of claim 10, the ultrasonic horn being mounted to traverse an energy application path over the anvil and a workpiece on the anvil, the energy application path being oriented transversely across the outer working surface, the ultrasonic system further comprising apparatus for simultaneously applying pressure and ultrasonic energy through the ultrasonic horn to the workpiece disposed on the anvil, at the point moving progressively across the workpiece, thereby to accomplish work on the workpiece while the ultrasonic horn is so traversing the energy application path and so applying pressure and ultrasonic energy to the workpiece.

16. The energy system of claim 10, wherein the energy comprises one or more of thermal energy generated by electrical resistance and pressure from a pressure bonder.

17. A method for applying energy to a workpiece comprising:
providing a complex workpiece having variable thickness and/or number of layers across a cross-direction;
positioning the workpiece between an anvil and an ultrasonic horn, wherein the ultrasonic horn has a bonder vibration amplitude, a bonder pressure, and a horn travel velocity, and wherein one of the ultrasonic horn and the anvil is fixe, and the other of the ultrasonic horn and the anvil is configured to travel across the workpiece and apply energy to the workpiece; and
customizing the energy delivered to the workpiece by controlling one or more of bonder vibration amplitude, bonder pressure, and horn travel velocity as a function of position on the workpiece and the thickness and/or number of layers of the workpiece at a given position.

18. The method of claim 17, wherein the anvil and the ultrasonic horn are used in conjunction with a rotating drum system.

19. The method of claim 17, wherein the anvil and the ultrasonic horn are used in conjunction with a conveyor system.

20. The method of claim 17, the ultrasonic horn being mounted to extend over the anvil, to apply pressure on a workpiece on the anvil, and thereby to apply ultrasonic energy to the workpiece while extended over the anvil.
